(19) United States
(12) Patent Application Publication
(10) Pub. No.: US 2003/0016535 A1
(43) Pub. Date: Jan. 23, 2003

(54) Posable string of lights

(76) Inventors: Wallace H. Wells JR., Welch, MN (US); Linda J. Wells, Welch, MN (US)

Correspondence Address: Wheeler Law Offices, P.C., 22 Washington Trust Building, Washington, PA, 15301, US

(21) Appl. No.: 09/908,286

(22) Filed: Jul. 18, 2001

(51) Int. Cl. F21V 11/00

(52) U.S. Cl. 362/240; 362/249; 362/252; 362/123

(57) ABSTRACT

A posable, bendable, string of decorative lights that can be formed into shapes and scenes by the user that includes a string of electrically circuited light bulb sockets togther with white or colored light bulbs, attached to a bendable, flexiable, wire, of such a type and gauge that the wire is easily bent and positioned without tools and will not break easily, and coated with an insulated protective coating. Can be used indoors or outdoors and can be connected to one another.

### RELATED APPLICATIONS

The present invention is a continuation of Disclosure Document Number 484,228 filed on Dec. 26, 2000.

### FIELD OF INVENTION

The present invention relates generally to holiday decorative lighting. More specifically, the present invention relates to holiday decorative lighting that is bendable and posable.

### BACKGROUND OF INVENTION

The holiday season is a time of fun and happiness for most everyone. A great deal of holiday cheer comes from yearly traditions that are passed from generation to generation. One holiday tradition that is enjoyed by many is decorating with holiday lights both within and without a person's home and/or business. When it comes to decorative lighting, however, one is limited to either pre-fabricated shapes that can be bought at a store or if one wishes to be creative with a traditional string of lights, one mist incorporate a board or background surface which the lights are shaped and then somehow affixed to ensure that they maintain their shape. This can be messy and time consuming. Consequently, the need has been felt for a string of lights that can be molded and formed without being mounted. The present invention fulfills this need.

Further, often during the Christmas holiday, due to personal commitments or death, loved ones cannot always be present. Such absence leaves an empty feeling in the hearts of those who missed their loved ones. While some decorations help to alleviate such empty feelings, traditionally there are no special lighted decorations created to represent a missing loved one. Consequently, the need for such device has been felt. The present invention fulfills this need.

### SUMMARY OF THE INVENTION

The posable string of lights is a device, available in many different colors, depending upon the holiday, either all the same color or multi-colored on the same string, that allows the user to bend, shape, and pose the lights into different shapes. The user can make lighted jack-o-lanterns for Halloween, candy canes for Christmas, and bunnies for Easter. The creative possibilities are limited only by user.

The posable string of lights is further a device and method by which to remember loved ones during the holiday season. In the event of a new American Indian Tradition, the posable string of lights is spiraled around the trunk of a Christmas tree. The glow from within the interior of the tree reminds the viewer of the spirit of the loved one who is absent physically, but is always present within one's heart.

It is a primary objective of the present invention to provide a decorative string of lights that can be easily shaped and posed into a variety of creative scenes and shapes.

It is further object of the present invention to provide a device and method by which loved ones are remembered.

### BRIEF DESCRIPTION OF DRAWINGS

The advantages and features of the present invention will become better understood with reference to the following more detailed description and claims taken in conjunction with the accompanying drawings, in which like elements are identified with like symbols, and in which:

FIG. 1 is a perspective view of the posable string of lights.

FIG. 2 is a perspective view of an alternate embodiment of the posable string of lights.

FIG. 3 is a perspective view of the posable string of lights within a protective plastice tube.

FIG. 4 depicts one possible creation with the posable string of lights.

FIG. 5. Depicts the posable string of lights spiraled around the trunk of a tree.

### DETAILED DESCRIPTION OF THE INVENTION

The posable string of lights 10 is a string of lights that is capable of being bent and molded into various shapes, designs, and poses.

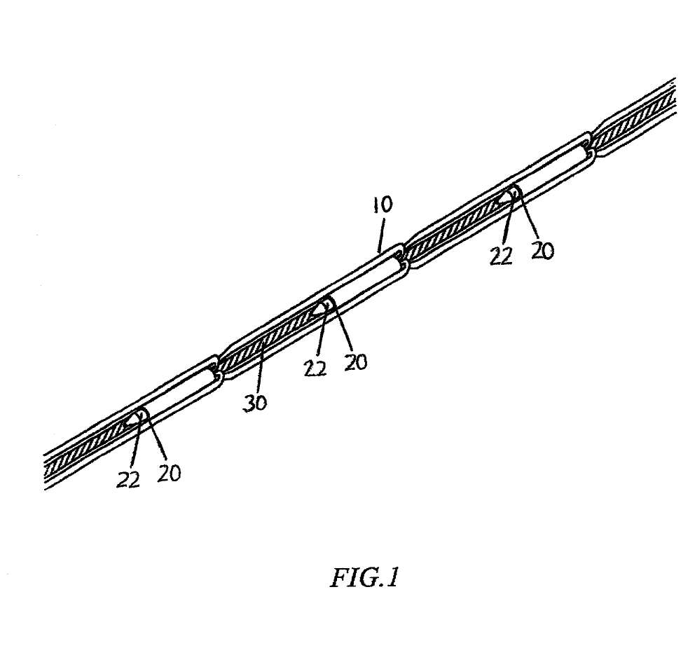

As shown in FIG. 1, the posable string of lights 10 includes a string of electrically circuited light bulb sockets 20 together with light bulbs 22 inserted therein (hereinafter referred to as “string of lights 24”). The light bulb sockets 20 in the preferred embodiment are sized to receive miniature decorative light bulbs 22. One of ordinary skill in the art would recognize that the bulb sockets 20 can be sized to receive any size light bulb 22. A smaller size light bulb 22 is preferred for creating holiday displays or scenes. One of ordinary skill in the art would further recognize that the distance between the light bulb sockets 20 can be any number of distances without altering the purpose and function of the present invention, ie: the light bulb sockets 20 can be as close together as side by side, touching one another, or as far apart as one at each end of the string of lights 24 or at any increment in between. For creating displays or scenes, it is preferred that the light bulb sockets 20 be two inches apart from one another.

In a preferred embodiment, the light bulb sockets 20 are wired in a parallel circuit to prevent the entire string of lights 24 from ceasing to glow when only one light bulb 22 is blown out. One of the ordinary skill in the art would recognize, however, that the string of lights 24 can be wired in a series circuit. Further, the light bulbs 22 can be any color imaginable. Different colors are preferred for different holidays and/or events. The string of lights 24 can be filled with light bulbs 22 of all the same color or with multicolored light bulbs 22 depending on the creativity of the user.

In a preferred embodiment a posable or stiffening wire 30 is attached to one side of the string of lights 24. In a preferred embodiment, the stiffening wire 30 is adhered with a permanent adhesive or glue (not shown) to the outside of the light bulb sockets 20. One of ordinary skill in the art would recognize that there are a number of ways in which the stiffening wire 30 can be attached to the string of lights 24, including, but not limited to soldering the stiffening wire 30 in place. In an alternative embodiment, the stiffening wire 30 is attached to the insulated electrical cored 21 instead of to the light bulb sockets 20. In the preferred embodiment the stiffening wire 30 is an insulated 10 gauge copper wire in order to provide the correct amount of stiffening and “posability”. One of ordinary skill in the art would recognize that other gauges and types of wires can be substituted for the insulated 10 gauge copper wire and that the gauge is dependent upon the type of wire as well as the performance. It is essential that the stiffening wire 30 is easily posable, bendable with breaking, and that the stiffening wire 30 holds the shape into which it is molded.

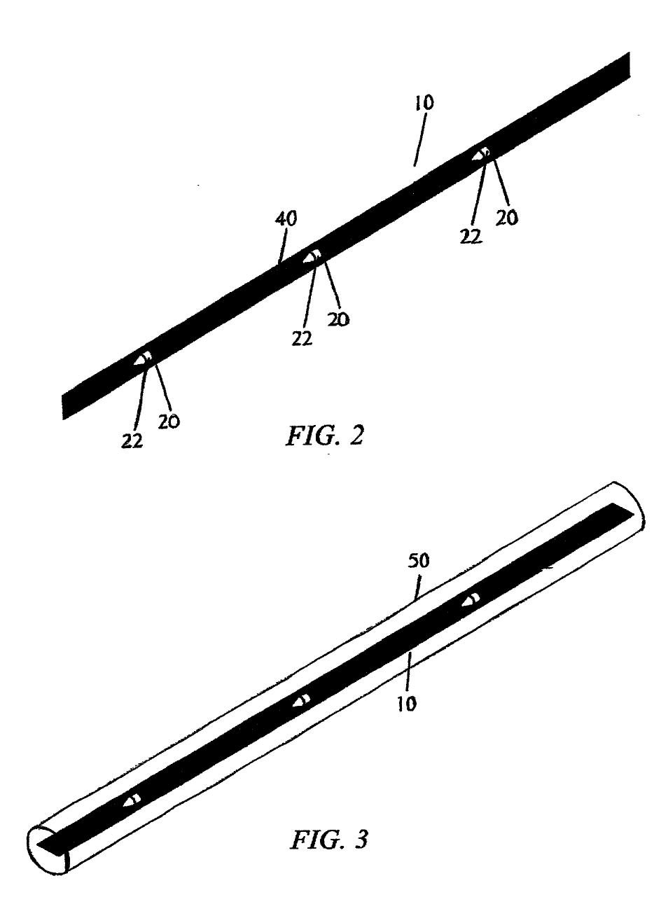

In a preferred embodiment, as seen in FIG. 2, after the stiffening wire 30 is attached to the string of lights 24, the stiffening wire 30 and string of lights 24 “combination” is covered with a protective coating 40 leaving the light bulb sockets 20 and light bulbs 22 uncovered and visible.

The protective coating 40 is preferably made of rubber. One of ordinary skill in the art would recognize that the protective coating 40 can be made of a number of different materials, including, but not limited to different types of plastics and/or epoxies. In a preferred embodiment, the protective coating 40 is sprayed on, ensuring that the light bulb sockets 20 are not covered. Further, the protective coating 40 must be flexible. It is apparent to one of ordinary skill in the art that the protective coating 40 can be adhered to the combination in a number of different ways, including, but not limited to a dipping process wherein the combination is dipped into a vat of coating, again without covering the light bulb sockets 20. It is further recognized by one of ordinary skill in the art that the string of lights 24 need not be covered with a protective coating 40 and can be left as seen in FIG. 1.

As shown in FIG. 3, in an alternative embodiment, the posable string of lights 10 is inserted into a pliable translucent shroud herein referred to as a pliable tube 50 for additional protection from the elements when used outdoors. In a preferred embodiment, the pliable tube 50 is constructed of a translucent, transparent plastic that can be easily molded without cracking. One of ordinary skill in the art would recognize, however, that the pliable tube 50 need not be clear and can be tinted any color imaginable.

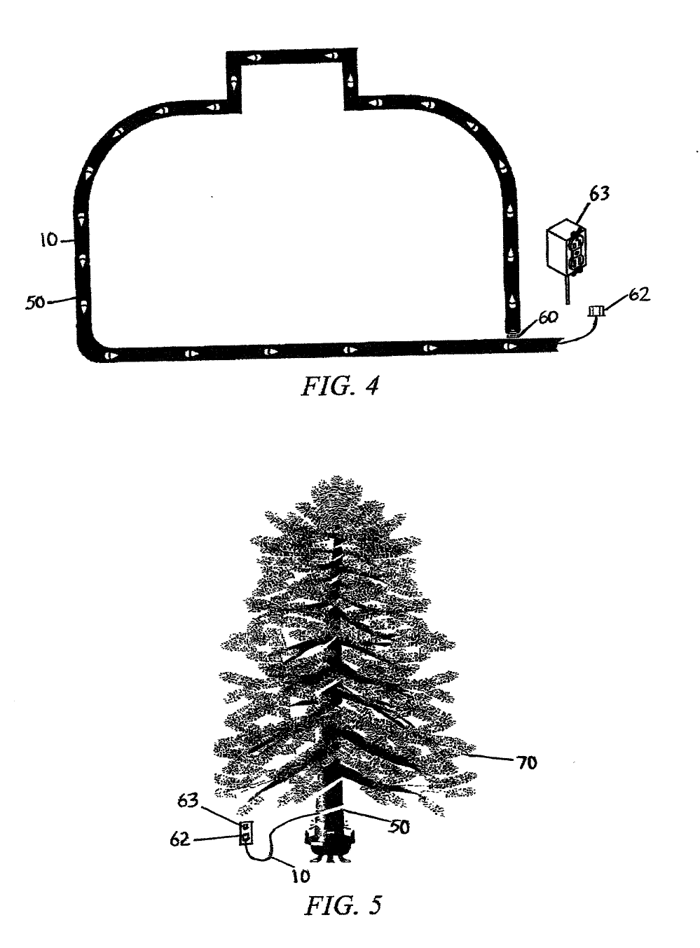

In a preferred embodiment, the posable string of lights 10 is available in a number of different lengths and is fitted with an electrical receiver 60 and electrical plug 62 for plugging one posable string of lights 10 into another posable string of lights 10 and/or into an electrical outlet 63 or extension cord (not shown), etc. See FIG. 4. A traditional string of lights can also be intermingled with the posable string of lights 10. It is preferred that the linght of the posable string of lights 10 be varied to allow users to be more creative with their designs. Also in a preferred embodiment, the posable string of lights 10 can be used indoors as well as outdoors.

The posable string of lights 10 molded into the decorative shape of a pumpkin is shown in FIG. 4.

FIG. 5 depicts the posable string of lights 10 after it has be spiraled around a trunk of a tree 70, creating an inner glow to the tree 70 and reminding the user of loved ones who cannot be physically present.

Although this invention has certain preferred embodiment, it will be obvious to those skilled in the art that various changes and modifications may be made therein without departing from the invention, and all such changes and modifications are intended to fall within the true spirit and scope of the invention.

What is claimed is:

1. A posable string of lights, comprising:
a string of electrically circuited light bulb sockets capable of accepting light bulbs; and,
a wire coupled to said string of electrically circuited light bulb sockets.

2. A posable string of lights according to claim 1 wherein said posable string of lights also comprises a pliable translucent shroud surrounding both said string of electrically circuited light bulb sockets and said wire.

3. A posable string of lights comprising:
a string of electrically circuited light bulb sockets capable of accepting light bulbs,
a wire coupled to said string of electrically sockets; and
a protective coating covering said string of electrically circuited lightbulb sockets said wire.

4. A posable strings of lights according to claim 3 wherein said posable string of lights also comprises a pliable translucent shroud surrounding both said string of electrically circuited light bulb socket and said wires.
